(19) United States
(12) Patent Application Publication
(10) Pub. No.: US 2007/0157787 A1
(43) Pub. Date: Jul. 12, 2007

(54) Bowstring tension meter

(76) Inventor: Ping-Sen Liao, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,408

(22) Filed: Jan. 6, 2006

(51) Int. Cl. G10D 1/02

(52) U.S. Cl. 84/282

(57) ABSTRACT

A bowstring tension meter for a stringed instrument to meter the tension of the bowstring for it to demonstrate optimal timbre includes a main body, a lid, a sensor, a control unit, a screen, and a cell cabinet. The main body is mounted to the bow with locating members. The main body further comprises a supporting member to support the bowstring in its loosened status. The sensor is disposed on the main body to detect the tension of the bowstring. The lid is secured to the main body and comprises the control unit, the screen, the cell cabinet. The control unit is to receive signals transmitted from the sensor. The screen is to display signals received by the control unit. The cell cabinet is to supply power to the meter.

### BACKGROUND OF THE INVENTION

(a) Field of the Invention

The present invention relates to a bowstring tension meter, and more particularly to one to meter the tension of the bowstring of a bow for a stringed instrument.

(b) Description of the Prior Art

As illustrated in FIGS. 8 and 9, a conventional bow (A) for a stringed instrument is provided with a screw (A1) at one end to adjust the tension of a bowstring (A2). When in use, the bowstring (A2) is in a tightened status and the extent of the tension will affects the timbre played by the stringed instrument. The higher tension adjusted will produce higher timbre; and lower, softer solely depending on the individual experience of the user. When the bow (A) is not used, the tension applied to the bowstring (A2) will be completely released to protect the bowstring (A2) and tightened up again as desired for playing the stringed instrument. However, to a player less experienced (e.g., a beginner), it is very difficult to readjust the bowstring (A2) for its optimal tension thus to frustrate the learning results.

### SUMMARY OF THE INVENTION

The primary purpose of the present invention is to provide a bowstring tension meter for a stringed instrument to meter the tension of the bowstring for the stringed instrument to demonstrate the best timbre.

To achieve the purpose, the present invention includes a main body, a sensor, a lid, a control unit, a screen, and a cell cabinet. The main body is provided with locating members for the main body to be mounted to the bow. The main body further comprises a supporting member to support the bowstring in its loosened status. The sensor is disposed on the main body to detect the tension of the bowstring. The lid is secured to the main body and accommodates installations of the control unit to receive signals transmitted from the sensor, the screen to display the signals received by the control unit, and the cell cabinet to contain a cell for supplying power to the meter.

The screen is disposed on an outer side of the lid; or alternatively is disposed independently from the lid. The transmission between the screen and the control unit is done by wired or wireless fashion. A switch is further provided to the lid to control the on or off of the meter.

Accordingly, the present invention provides the advantages including that it displays the proper data for the user of the stringed instrument to properly adjust the tension of the bowstring of the bow; and that it is particularly helpful to a beginner in learning to play the stringed instrument.

### BRIEF DESCRIPTION OF THE DRAWINGS

FIG. 1 is a front perspective view of a preferred embodiment of the present invention.

FIG. 2 is a rear perspective view of the preferred embodiment of the present invention.

FIG. 3 is a schematic view showing that the preferred embodiment of the present invention is mounted to a bow.

FIG. 4 is a side sectional view showing that the preferred embodiment of the present invention is mounted to the bow.

FIG. 5 is a schematic view showing that the bowstring is in a loosened status with the preferred embodiment of the present invention mounted to the bow.

FIG. 6 is a schematic view showing the operation of the preferred embodiment of the present invention mounted to the bow.

FIG. 7 is a front perspective view of another preferred embodiment of the present invention.

FIG. 8 is a side view of a conventional bow of a stringed instrument.

FIG. 9 is a side view showing that the bowstring of the bow is in its loosened status.

### DETAILED DESCRIPTION OF THE PREFERRED EMBODIMENTS

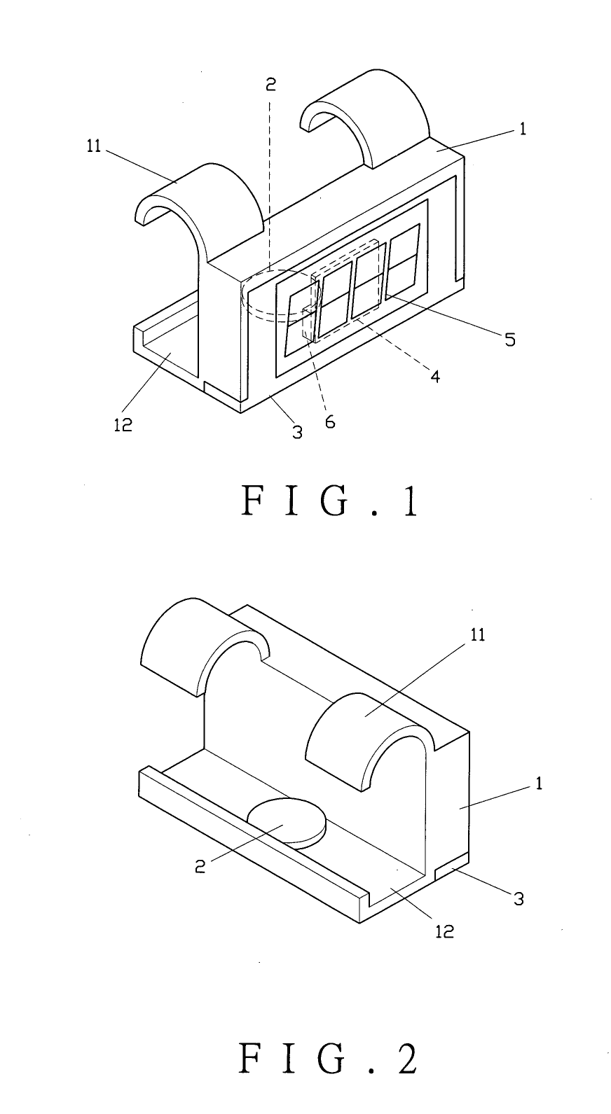

Referring to FIGS. 1 and 2, a preferred embodiment of the present invention includes a main body (1), a sensor (2), a lid (3), a control unit (4), a screen (5), and a cell cabinet (6) incorporated with a bow (A) and its bowstring (A2) for a stringed instrument.

The main body (1) is mounted to the bow (A) by means of locating members (11). The main body (1) is provided with a supporting member (12) to support the bowstring (A2) in its loosened status. The sensor (2) is disposed on the supporting member (12) of the main body (1) to detect the tension of the bowstring (A2). The lid (3) is secured to the main body (1) and comprises the control unit (4), the screen (5), and the cell cabinet (6). The control unit (4) receives signals transmitted from the sensor (2). The screen (5) displays the signals received by the control unit (4). The cell cabinet (6) contains a cell to supply power.

As illustrated in FIG. 1, the screen (5) is disposed on the lid (3). Alternatively, the screen (5) may be disposed independently from the lid (3) (not illustrated). The control unit (4) transmits signals either in wired or wireless fashion.

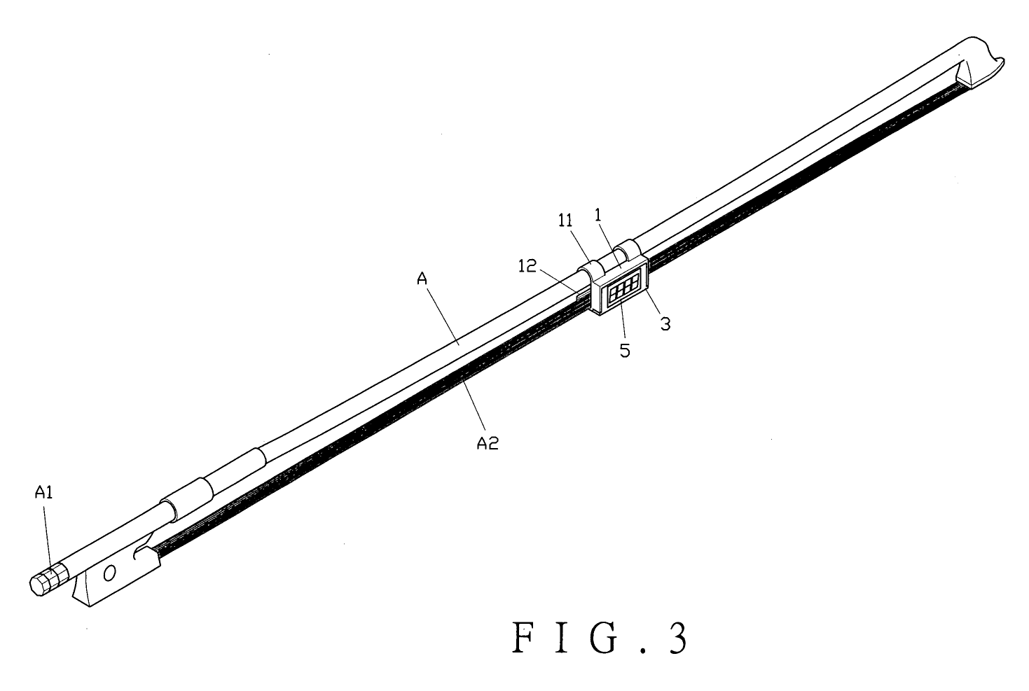

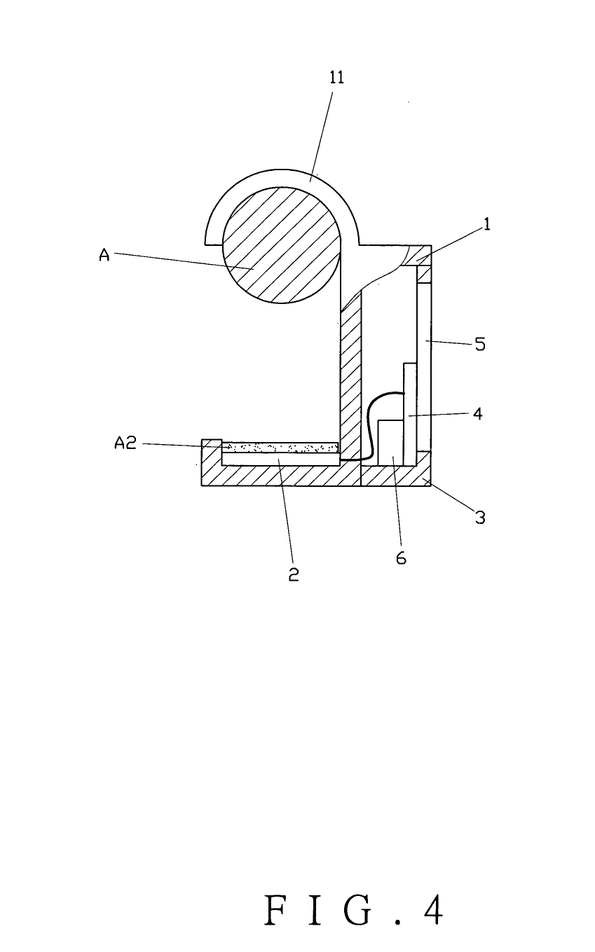

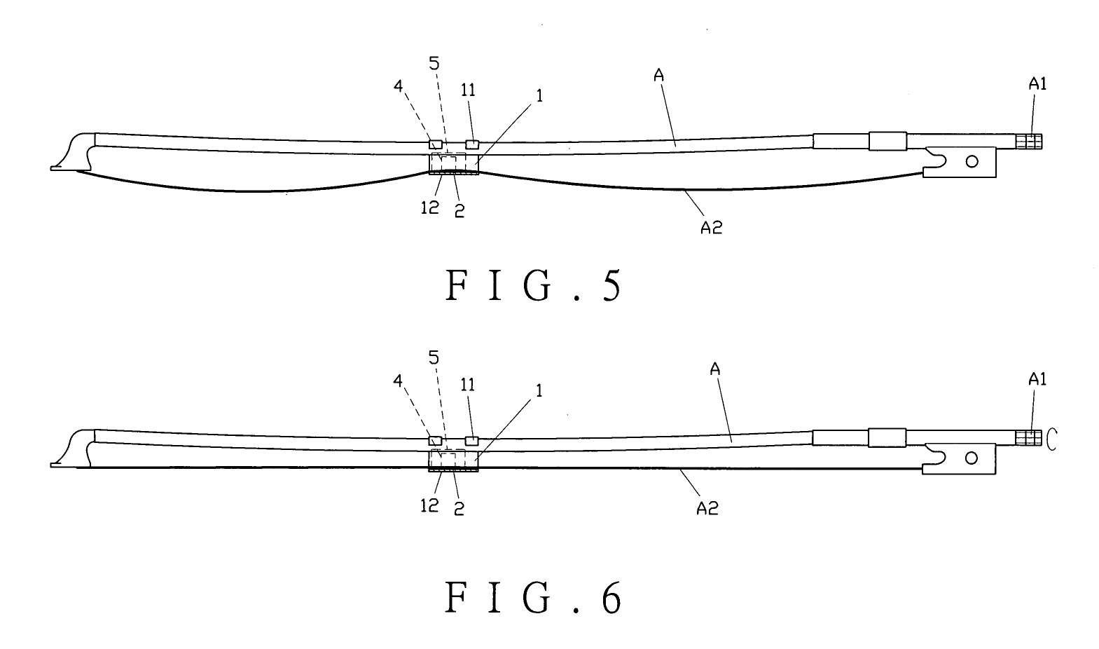

Now referring to FIG. 3 for the status showing the preferred embodiment of the present invention is mounted to the bow (A), the main body (1) is secured to the bow (A) by means of the locating members (11). FIGS. 4, 5, and 6 show the operation status of the preferred embodiment of the present invention. As illustrated in FIGS. 4 and 5, the bowstring (A2) is in a loosened status, and the bowstring (A2) is flush with the sensor (2) and drooping over the supporting member (12). As shown in FIG. 6, a screw (Al) provided on the bow (A) is turned to gradually tighten up the bowstring (A2). As the bowstring (A2) is being tightened up, it applies pressure on the sensor (2), and the sensor (2) in turn coverts the pressure into signals to be transmitted to the control unit (4). The control unit (4) further transmits the signals received to the screen (5). As the tension to the bowstring (A2) mounts up, the sensor (2) keeps on transmitting the signals to the control unit (4) where the signals received are further transmitted to the screen (5). Accordingly, as long as the screw (Al) is turned to keep on adjusting the tension of the bowstring (A2), the screen (5) continues to adjust the display of the reading of the tension until the user is assured of the reading desired to stop turning the screw (Al).

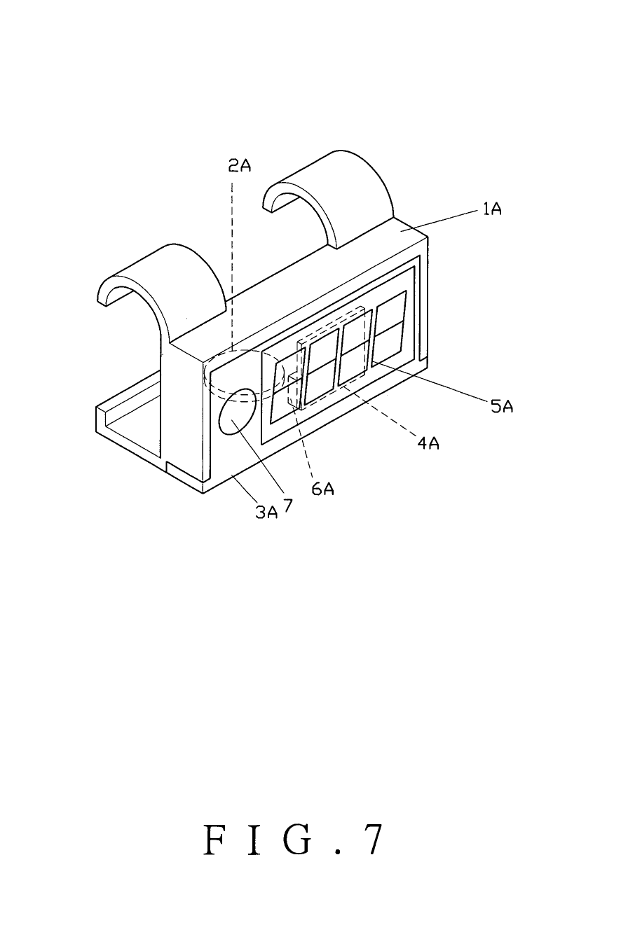

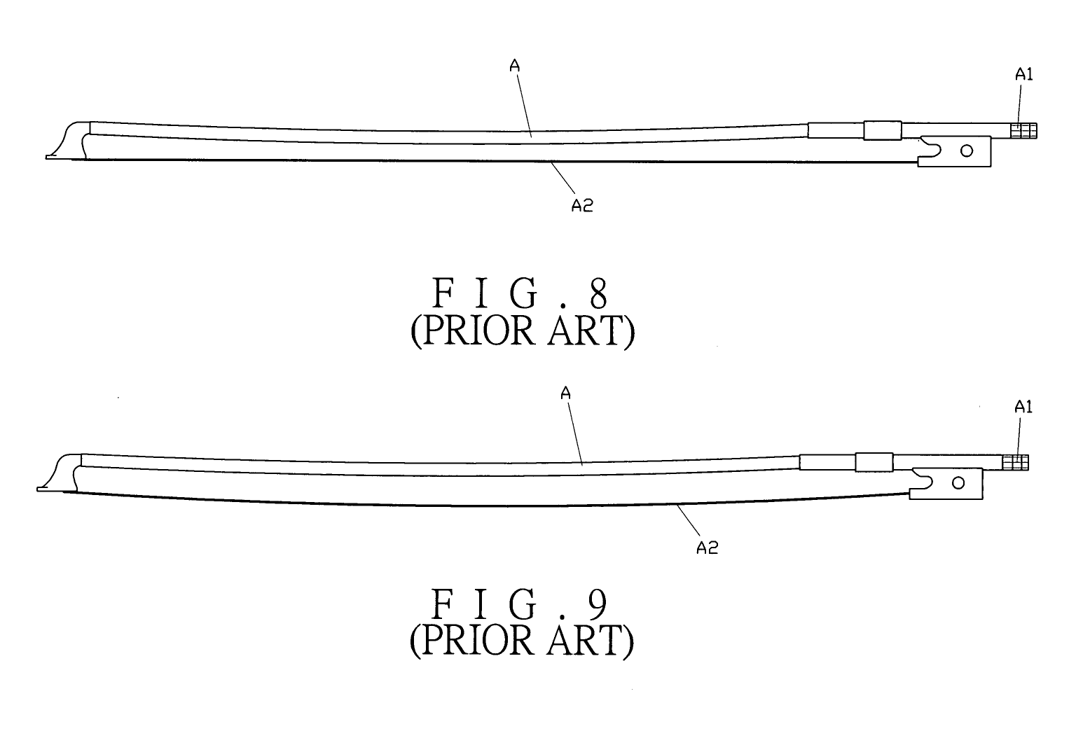

As illustrated in FIG. 7, another preferred embodiment of the present invention includes a main body (1A), a sensor (2A), a lid (3A), a control unit (4A), a screen (5A), a cell cabinet (6A), and a switch (7) to control the power on or off.

What is claimed is:

1. A bowstring tension meter for a stringed instrument including a main body, a sensor, a lid, a control unit, a screen, and a cell cabinet incorporated with a bow and a bowstring;
the main body being secured to the bow by means of locating members;
the sensor being disposed to the main body to detect the tension of the bowstring and transmit signals of the tension detected to the control unit;
the lid being disposed to the main body and comprising the control unit;
the control unit receiving the signals transmitted from the sensor and sending the signals to the screen;
the screen displaying the signals received from the control unit; and
the cell cabinet being to supply power.

2. The bowstring tension meter of claim 1, wherein the main body further comprises a supporting member to support the bowstring in a loosened status.

3. The bowstring tension meter of claim 1, wherein the screen is disposed on an outer side of the lid.

4. The bowstring tension meter of claim 1, wherein the screen is disposed independently from the lid.

5. The bowstring tension meter of claim 1, wherein the transmission between the screen and the control unit is in a wired fashion.

6. The bowstring tension meter of claim 1, wherein the transmission between the screen and the control unit is in a wireless fashion.

7. The bowstring tension meter of claim 1, wherein the lid further comprises a switch.
